(19) United States
(12) Patent Application Publication
(10) Pub. No.: US 2003/0221034 A1
(43) Pub. Date: Nov. 27, 2003

(54) Add-on card for connecting to both wired and wireless networks

(76) Inventor: Chang-Yi Cheng, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/063,898

(22) Filed: May 22, 2002

(51) Int. Cl. G06F 13/00

(52) U.S. Cl. 710/301

(57) ABSTRACT

An add-on card for a computer is detachable from the computer and allows the computer to communicate with both wired and wireless networks. The add-on card includes an access control circuit, volatile and non-volatile memory, a wireless transmission module, and a network connection module. The network connection module has both an antenna for communicating with a wireless network, and a standard network cable port for connecting to a wired network. The network connection module can be detachable from the add-on card to allow for various network configurations.

### BACKGROUND OF INVENTION

1. Field of the Invention

The present invention relates to an add-on card for a computer, and more particularly, to an add-on card for connecting to both wired and wireless networks.

2. Description of the Prior Art

In this modern information based society, people frequently access information through computer networks facilitating the accumulation of knowledge and information, and advancing the development of society. As electronics technology progresses, small portable computers become increasingly popular. Computer manufactures devote themselves to developing the technology and equipment necessary for connecting portable computers to networks so that consumers are able to have convenient network access at any time and place.

In order to increase the functionality and flexibility of portable computers, portable computers are equipped with expansion slots. Add-on cards with specific functions can be installed into these expansion slots. For example, typical notebook computers have slots complying with the PCMCIA (Personal Computer Memory Card International Association) specification for installing add-on cards into so that the functionality of the computer is increased. In the prior art, add-on cards for connecting to a network, or network cards, are divided into two categories. One category is for connecting to a wired network, and the other is for connecting to a wireless network. In a wired network, the portable computer is connected to the network via a network transmission line. Similarly a wireless network card lets the portable computer connect to a wireless network via electromagnetic waves or infrared radiation.

Compared to the wireless network, the wired network has an infrastructure that is more established, higher connection speeds, and easier maintenance of data security. The wireless network, however, offers users more mobility.

In the prior art, the network card has only a single function for either connecting to a wired network or for connecting to a wireless network. If users want both features, they must install the two kinds of network cards, and thus use up two slots in their computer. This is an inconvenience and a waste of resources especially if the user requires a free slot for another application.

### SUMMARY OF INVENTION

It is therefore a primary objective of the claimed invention to provide an add-on card for connecting to both wired and wireless networks.

In a preferred embodiment, the claimed invention provides an add-on card used on a computer. The computer comprises a housing and a first connection port positioned on the housing. The add-on card comprises a second connection port separably connected to the first connection port for receiving data transmitted from the computer. An access control circuit is electrically connected to the second connection port for converting the data transmitted from the second connection port into first format data and second format data. A wireless transmission module is electrically connected to the access circuit for modulating the first format data into a transmission signal.

The preferred embodiment also includes a network connection module. The network connection module comprises an antenna circuit connected to the wireless transmission module for converting the transmission signal into a first network signal transmitted via wireless transmission so that the first network signal is transmitted to a wireless network system. A connecting circuit is connected to the access control circuit for converting the second format data into a second network signal. A network transmission line is connected to the connecting circuit for transmitting the second network signal to a wire network system.

It is an advantage of the claimed invention that the add-on card utilizes only one slot in the computer to connect to both wired and wireless networks.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a perspective diagram showing an add-on card and a portable computer according to a first embodiment of the present invention.

FIG. 2 is a functional block diagram of the add-on card in FIG. 1 connected to the portable computer.

FIG. 3 is a perspective diagram of an add-on card according to a second embodiment of the present invention.

FIG. 4 is a functional block diagram of the add-on card in FIG. 3 connected to the portable computer.

### DETAILED DESCRIPTION

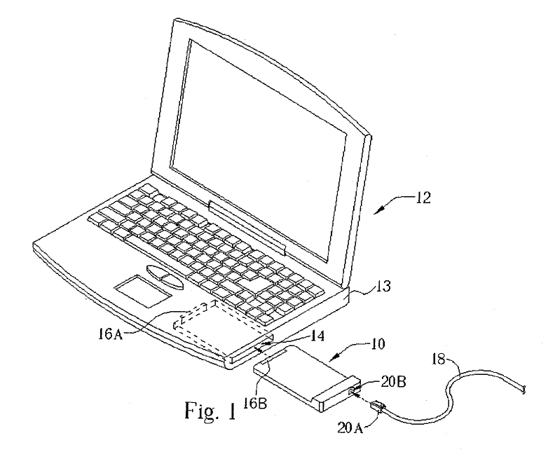

Please refer to FIG. 1. FIG. 1 is a perspective diagram of an add-on card 10 applied to a portable computer 12 according to a first embodiment of the present invention. The portable computer 12 is enclosed in a housing 13. A concave slot 14 is installed in the housing 13, and a first connection port 16A is installed inside the slot 14. The slot 14 can be a slot complying with the PCMCIA standard. The add-on card 10, which is the same standard as the slot 14, comprises a second connection port 16B corresponding to the first connection port 16A installed at one end of the add-on card 10. The add-on card 10 also includes a connecting port 20B, a RJ45 connecting port for example, installed at the other end of the add-on card 10. A network transmission line 18 for a wired network comprises a connector 20A that is capable of connecting with the connecting port 20B of the add-on card 10. When the connector 20A is plugged into the connecting port 20B, the add-on card 10 will be connected to the wired network via the network transmission line 18.

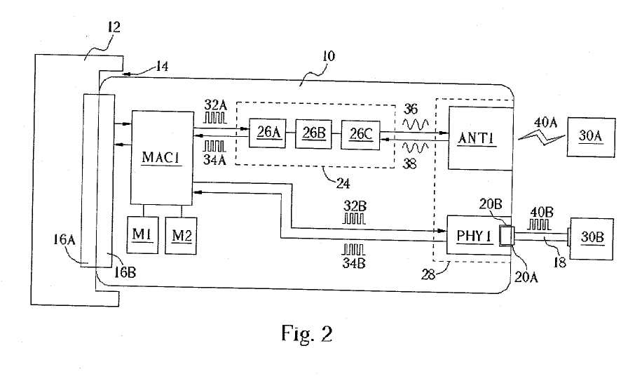

Please refer to FIG. 2. FIG. 2 is a functional block diagram of the add-on card 10 connected with the portable computer 12. When the add-on card 10 is plugged into the slot 14 of the portable computer 12, the first connection port 16A will be electrically connected to the second connection port 16B and transmit signals with the second connection port 16B. The add-on card 10 of the present invention comprises an access control circuit MAC1, a volatile memory M1 and a non-volatile memory M2 (both of which are connected to the access control circuit MAC1), a wireless transmission module 24, and a network connection module 28. The wireless transmission module 24 comprises a base frequency circuit 26A, an intermediate frequency circuit 26B, and a radio frequency circuit 26C. The network connection module 28 comprises an antenna circuit ANT1 and a connecting circuit PHY1. The access control circuit MAC1 is connected to the second connection port 16B, and communicates with the portable computer 16 via the first connection port 16A.

The main function of the access control circuit MAC1 is for controlling the operations of the add-on card 10 when connected to the network. The volatile memory M1 can be a random access memory, providing temporary memory space for the access control circuit MAC1 when it is operating. The non-volatile memory M2 can be a flash memory for storing the necessary information, such as the address data required by the add-on network card, in a non-volatile manner when the access control circuit MAC1 is operating. Using this address data, the add-on card 10 can be identified by the network. The base frequency circuit 26A, intermediate frequency circuit 26B, and radio frequency circuit 26C of the wireless transmission module 24 can separately modulate the data transmitted from the access control circuit MAC1 to the base, intermediate and radio signals. The antenna circuit ANT1 connected to the radio frequency circuit 26C can transmit the radio signals in a wireless manner. When the antenna receives the wireless radio signals, radio frequency circuit 26C, intermediate frequency circuit 26B, and the base frequency circuit 26A in the wireless transmission module 24 will separately demodulate the signals into data in the form of a bit stream. This data is then transmitted to the access control circuit MAC1. In other words, the add-on card 10 can provide the means of connecting to a wireless network by using the access control circuit MAC1, wireless transmission module 24, and antenna circuit ANT1.

Similarly, the connecting circuit PHY1 in the network connection module 28 is connected to the access control circuit MAC1. The connecting circuit PHY1 encodes the data transmitted from the access control circuit MAC1, and transmits the encoded data to the network transmission line 18 via the connecting port 20B and connector 20A so as to connect to the network in a wired manner. When the encoded data is received via the network transmission line 18, the connecting circuit PHY1 will decode the encoded data and transmit the decoded data to the access control circuit MAC1. In other words, the add-on card 10 can further provide the functionality of connecting to a wired network by using the access control circuit MAC1, the connecting circuit PHY1, and the network transmission line 18.

The connecting circuit PHY1 can also detect the electrical characteristic of the signal over the network transmission line 18 so as to detect if a signal collision has occurred over the network transmission line 18. A collision is defined as when a signal is sent out over the network transmission line 18 and another signal is received at the same time, both signals becoming incoherent. For example, a device built in accordance with the specification IEEE 802.3,which is usually applied to wired networks, detects the signal collision by the electrical characteristic of the carrier wave over the network transmission line using a method called Carrier Sensitive Multiple Access/Collision Detection (CSMA/CD). The detection result of the connecting circuit PHY1 is transmitted to the access control circuit MAC1, and the access control circuit MAC1 determines the operation of the data transmission according to this detection result. Specifically, a collided signal will be resent after a certain period has passed since the collision.

The operation of the present invention is described as follows. When a user connects the portable computer 12 to the network via the add-on card 10 of the present invention and transmits data to the network, this data is transmitted to the access control circuit MAC1 via the first connection port 16A and the second connection port 16B. According to a specific network transmission protocol, the access control circuit MAC1 will add a header to the front of this data. The header comprises the address of the add-on card, the address of the receiving end add-on card, and other relevant information. Furthermore, the access control circuit MAC1 calculates and attaches an error detection code to the end of this data. Accordingly, this data and information becomes a network data packet. The network transmission protocols of the wired and wireless networks are likely to be different, as the wireless network transmission protocol further requires security related identification data to be included in the data packet. The access control circuit MAC1 can package the data to comply with a first data format of the wireless network transmission protocol so as to transmit to the wireless network, or comply with a second data format of the wired network transmission protocol so as to transmit to the wired network.

As mentioned above, data to be transmitted to the wireless network 30A is packaged into a first format data 32A by the access control circuit MAC1. For example, the data is packaged according to the transmission protocol of wireless area networks IEEE802.11. The first format data 32A is then transmitted to the wireless transmission module 24 in the form of bit stream. The base frequency circuit 26A, intermediate frequency circuit 26B, and radio frequency circuit 26C in the wireless transmission module 24 modulate the data into the radio frequency transmission signal 36 for wireless transmission. The antenna circuit ANT1 transforms the radio frequency transmission signal 36 into a first network signal 40A,having the form of an electromagnetic wave, and transmits the data to the wireless network 30A.

When the antenna circuit ANT1 receives a network signal in the form of electromagnetic waves transmitted from the wireless network 30A, the antenna circuit ANT1 transforms the network signal into a received signal 38. The wireless transmission module 24 then demodulates the received signal 38 into a received data 34A to be transmitted to the access control circuit MAC1. The data received from the wireless network 30A is packaged based on the wireless network transmission protocol. The access control circuit MAC1 extracts the data packaged in the received data 34A, and transmits the data to the portable computer 12 via the first connection port 16A and the second connection port 16B. Therefore, the portable computer 12 can receive the data transmitted from the wireless network 30A so as to connect to the network wirelessly.

Data to be transmitted to the wired network 30B is packaged into a second format data 32B. For example, the data can be packaged according to the transmission protocol of a wired network IEEE802.3.The second format data 32B is then transmitted to connecting circuit PHY1 in the form of bit stream. The connecting circuit PHY1 encodes the data into a second network signal 40B, and transmits the second network signal 40B to the wired network 30B via the network transmission line 18.

When the network signal is transmitted to the connecting circuit PHY1 via the network transmission line 18, the connecting circuit PHY1 decodes it into a received signal 34B. The access control circuit MAC1 extracts data packaged in the received data 34B, and transmits the data to the portable computer 12 via the first connection port 16A and the second connection port 16B. Therefore, the portable computer 12 can access the data over the wired network 30B.

In summary, under the control of the access control circuit MAC1, the add-on card of the present invention can provide the functionality of connecting to both wired and wireless networks.

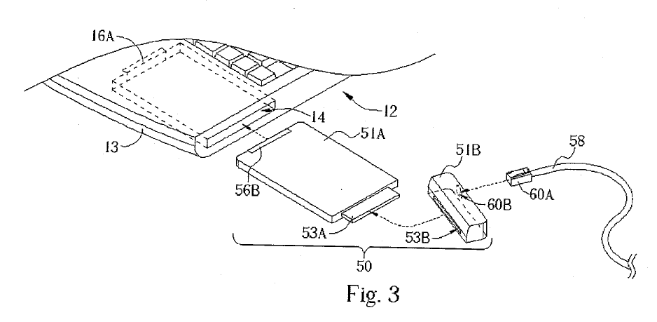

Please refer to FIG. 3. FIG. 3 is a perspective diagram of an add-on card 50 according to a second embodiment of the present invention. The main difference between the first and second embodiments is that the add-on card 50 comprises a first portion 51A and a detachable second portion 51B. Similar to the first embodiment, the first portion 51A comprises a second connection port 56B for connecting to the first connection port 16A in the slot 14 of the portable computer 12. The second portion 51B also comprises a connecting port 60B for accepting a connector 60A of a network transmission line 58 so that the network transmission line 58 can be detachably connected the second portion 51B. In addition, the first portion 51A and second portion 51B respectively comprise transmission ports 53A and 53B, allowing the first portion 51A and second portion 51B to be detachably connected.

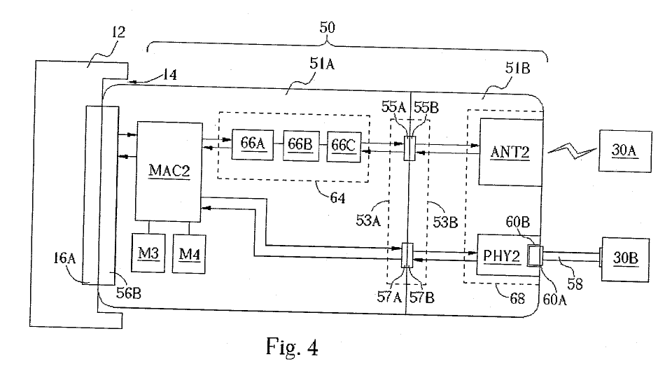

Please refer to FIG. 4. FIG. 4 is a functional block diagram of the add-on card 50 connected with the portable computer 12. The first portion 51A of the add-on card 50 includes an access control circuit MAC2, a volatile memory M3, and a non-volatile memory M4. The first portion 51A also has a base frequency circuit 66A, an intermediate frequency circuit 66B, and a radio frequency circuit 66C all of a wireless transmission module 64.The second portion 51B includes an antenna circuit ANT2 and a connecting circuit PHY2, both of a network connection module 68. All these components in both sections of the add-on card 50 have the same function as those with the same names in the add-on card 10 and operate in the same manner together. The key difference between the add-on card 50 and the add-on card 10 is that the components of the add-on card 50 are separated into the detachable first portion 51A and second portion 51B. In the add-on card 50, the network connection module 68 is installed in the second portion 51B, and the remaining components are installed in the first port 51A. The transmission ports 53A and 53B of the first portion 51A and second portion 51B respectively comprise first sub-transmission ports 55A, 55B and second sub-transmission ports 57A, 57B. The wireless transmission module 64 in the first portion 51A is connected to the antenna circuit ANT2 in the second portion 51B via the first sub-transmission ports 55A and 55B. The access control circuit MAC2 in the first portion 51A is connected to the connecting circuit PHY2 in the second portion 51B via the second sub-transmission ports 57A and 57B.

After the first portion 51A is connected to the second portion 51B, the access control circuit MAC2 will control the wireless transmission module 64 and antenna circuit ANT2 to be connected to the wireless network 30A. The access control circuit MAC2 can also control the connecting circuit PHY2 to be connected to the wired network 30B via the network transmission line 58. The advantage of having the network connection module 68 removable is that users can change the network connection module based on changing requirements. Various network constructions may require antenna circuits with different power outputs or may use different standards of network transmission lines. Accordingly, a corresponding network connection module is needed. Unique network connection modules can be built into different second portions, and the user has only to install a second portion equipped with the desired network connection module. Therefore, this embodiment uses the add-on card of the present invention to connect to both wired and wireless networks while flexibly meeting the demands of different network constructions. Additionally, the antenna circuit ANT2 can also be detachably installed into the second portion so it can be easily replaced.

In contract to the prior art, the add-on card of the present invention utilizes only one slot in the computer to connect to both wired and wireless networks. This allows computer users to use their resources more effectively, and satisfies the demand for diverse network connections and information access.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. An interface card used on a computer, the computer comprising
a housing and a first connection port positioned on the housing, the interface card comprising:
a second connection port seperably connected to the first connection port for receiving data transmitted from the computer;
an access control circuit electrically connected to the second connection port for converting the data transmitted from the second connection port into first format data and second format data;
a wireless transmission module electrically connected to the access circuit for modulating the first format data into a transmission signal; and
a network connection module comprising:
an antenna circuit connected to the wireless transmission module for converting the transmission signal into a first network signal transmitted via wireless transmission so that the first network signal is transmitted to a wireless network system;
a connecting circuit connected to the access control circuit for converting the second format data into a second network signal; and
a network transmission line connected to the connecting circuit for transmitting the second network signal to a wire network system.

2. The interface card of claim 1 wherein the antenna circuit is capable of receiving signals transmitted from the wireless network system, and demodulates the received signals into network packet data so that the access control circuit is capable of converting the network packet data into corresponding data.

3. The interface card of claim 1 wherein the connecting circuit is capable of receiving signals transmitted from the wire network system, and demodulates the received signal into network packet data so that the access control circuit is capable of converting the network packet data into corresponding data.

4. The interface card of claim 1 further comprising a non-volatile memory for storing information required by the access control circuit.

5. The interface card of claim 1 further comprising a volatile memory for storing information required by the access control circuit.

6. The interface card of claim 1 wherein the network connection module is separately connected to the access control circuit.

7. The interface card of claim 1 wherein the antenna circuit is separately connected to the network connection module.

8. The interface card of claim 1 wherein the first format data complies with a specification of IEEE 802.11.

9. The interface card of claim 1 wherein the second format data complies with a specification of IEEE 802.3.

10. The interface card of claim 1 wherein the access control circuit attaches a header to the data transmitted from the second connection port for generating the first format data and second format data.

11. The interface card of claim 10 wherein the header comprises physical address information of the interface card.

12. The interface card of claim 1 wherein the access control circuit attaches a checksum to the data transmitted from the second connection port for generating the first format data and second format data.
